(19) United States
(12) Patent Application Publication
(10) Pub. No.: US 2006/0143424 A1
(43) Pub. Date: Jun. 29, 2006

(54) Virtual storage architecture management system, information processing equipment for virtual storage architecture, computer- readable storage medium, and method of producing virtual storage architecture

(75) Inventors: Noriaki Matsuzaki, Kato (JP); Fumikazu Fujimoto, Kato (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/108,122

(22) Filed: Apr. 18, 2005

(30) Foreign Application Priority Data
Dec. 24, 2004 (JP) 2004-375087

(51) Int. Cl. G06F 12/00; G06F 12/16

(52) U.S. Cl. 711/170; 711/114

(57) ABSTRACT

A virtual storage architecture management system for producing a virtual storage architecture on the basis of information on a storage device comprises a storage device having a plurality of storage areas, information processing equipment that performs various kinds of information processing on the storage device, and a selective linkage unit that establishes a plurality of paths between the information processing equipment and the plurality of storage areas in the storage device. The information processing equipment includes a control unit that retrieves information on the real configuration of the storage device and information on the paths from an information preserver, and calculates information on all paths required for a virtual storage architecture. Also disclosed is a method for producing a virtual storage architecture using the virtual storage architecture management system, or the like, according to the present invention.

### BACKGROUND OF THE INVENTION

1. Field of the Invention

The present invention relates to a virtual storage architecture management system that realizes a virtual storage architecture on the basis of information (data) on a plurality of storage areas in a storage device, information processing equipment for producing a virtual storage architecture, a computer-readable storage medium, and a method of producing a virtual storage architecture.

In particular, the present invention refers to a technique for reliably managing information in a large-capacity storage device such as a disk array on a centralized basis by registering information, which is divided into pieces of information and stored in a plurality of storage areas subordinate to a plurality of zones, in a common pool of virtual storage.

2. Description of the Related Art

In general, in a network environment such as a storage area network (SAN) in which a large-capacity storage device such as a disk array is employed, a plurality of specific command lines sent from a server is used to perform information processing on the storage device. At this time, a storage medium such as a disk included in the storage device is divided into a plurality of zones, and the plurality of command lines sent from the server and the plurality of zones are grouped together (called “zoning”). This is intended to avoid the risk that the information in the storage device may be rewritten or deleted by executing an incorrect command line. Furthermore, a plurality of storage areas, that are logically separated from one another, is subordinate to the plurality of zones in the storage device. The storage areas may be referred to as logical volumes. The plurality of logical volumes is dominated by the plurality of zones.

On the other hand, part of information in a storage device such as a disk array must be managed comprehensively. In this case, information is fetched from a plurality of logical volumes subordinate to a plurality of zones selected by an operator or the like, and registered in a pool of virtual storage. Thus, a virtual storage architecture is produced, in general.

Typically, in a SAN or any other network environment in which a conventional virtual storage architecture is realized, a virtual storage architecture management system includes a large-capacity storage device such as a disk array. The storage device includes a storage medium such as a disk that has a plurality of zones, which is grouped together in association with a plurality of command lines sent from a server, and that also has a plurality of storage areas (may be called logical volumes) dominated by the plurality of zones. Furthermore, the storage device includes a storage device control unit that controls writing or reading of information in or from the storage medium according to the plurality of command lines. Furthermore, the storage device control unit includes a plurality of storage medium controllers (for example, controllers YY0 and YY1) that mutually and independently controls the plurality of zones, and a plurality of interface adaptors (for example, adaptors XX0 and XX1) that serves as an interface between the server and the plurality of storage medium controllers.

The virtual storage architecture management system includes a server that has the ability to transmit a plurality of command lines (for example, command lines HBA0, HBA1, HBA2, and HBA3 produced by an operating system (OS) of the server), which is produced and stored in advance, to the storage device so as to perform various kinds of information processing including writing and reading of information on the storage device.

Furthermore, in the virtual storage architecture management system, a server/storage device selective linkage unit that selectively links the plurality of command lines sent from the server with the plurality of zones in the storage device so as to group the plurality of commands and the plurality of zones together is interposed between the server and the storage device. The server/storage device selective linkage unit has the ability to establish a plurality of paths (or multiple paths), which links the plurality of command lines sent from the server with the plurality of zones in the storage device, by linking the plurality of command lines with the plurality of zones in response to an operator's request, so that the command lines and zones can be switched to others.

Part of the information stored in the storage medium included in the storage device may have to be managed comprehensively. In this case, a virtual storage architecture must be produced based on information on a plurality of logical volumes linked to a plurality of paths which is selected by an operator or the like and which is established between a plurality of command lines and a plurality of zones.

Specifically, information on a plurality of logical volumes linked to a plurality of paths selected by an operator or the like is conceptually registered in a pool of a virtual storage. Thus, a virtual storage architecture is realized.

To be more specific, in the conventional virtual storage architecture management system, a plurality of paths is established, by way of a plurality of storage medium controllers and a plurality of interface adaptors, between a plurality of command lines sent from the server and a plurality of zones in the storage device. In the above example, four paths HBA0-XX0YY0, HBA1-XX0YY0, HBA2-XX1YY0, and HBA3-XX1YY1 are established. In order to produce a virtual storage architecture, a plurality of logical volumes linked to the respective paths must be sequentially registered in a pool of virtual storage.

In the conventional virtual storage architecture management system, as the foregoing four paths are established, when an operator or the like manipulates a keyboard included in an input unit so as to execute a command line interface (CLI) command, a plurality of logical volumes linked to the paths is registered in a pool of a virtual storage. What is referred to as the CLI command is a control command (often accompanied by arguments) extracted from a command line contained in the OS of the server.

In order to register a plurality of logical volumes in a pool of a virtual storage using the CLI command, the CLI command must be issued four times. However, if the CLI command is issued only three times because of an operator's incorrect keystroke, a virtual storage architecture having three paths is incorrectly produced instead of a virtual storage architecture having four paths.

At the time of introduction of a virtual storage architecture management system, an operator may want to check if a virtual storage architecture having four paths is produced precisely. In this case, the operator must perform time-consuming manipulations. Therefore, the above problem cannot be avoided in practice because it is time-consuming to check the virtual storage architecture at the time of introduction of the virtual storage architecture management system. Consequently, an incorrect definition or the like may be discovered in a virtual storage architecture while the virtual storage architecture management system is in operation. In this case, the work of registering a plurality of logical volumes in a pool of a virtual storage must be resumed from the beginning. This poses a serious problem.

On the other hand, when pieces of information on a plurality of logical volumes included in a plurality of storage devices are registered in a pool of a virtual storage, consideration must be taken into the performance of a virtual storage architecture. Moreover, the types of storage devices must be identified, and a redundancy level of the configuration of a redundant array of inexpensive disks (RAID) adopted for redundancy of the storage devices must be recognized. Therefore, an operator himself/herself must recognize the real configurations of the plurality of storage devices, identify to which of the storage devices the logical volumes to be registered belong, and recognize a redundancy level of an adapted RAID configuration, that is, an RAID level.

Even in this case, logical volumes that should not be registered in the same pool of a virtual storage may be incorrectly registered because of an operator's incorrect keystroke. Similarly to the foregoing case, it is hard to check a virtual storage architecture at the time of introduction of a virtual storage architecture management system. Consequently, an incorrect definition or the like may be discovered in the virtual storage architecture while the virtual storage architecture management system is in operation. This poses a serious problem.

For reference, patent document 1 (System Permitting Allocation in Units of Logical Unit in Storage Device) and patent document 2 (Virtual Device Realized with Multiple Files of Different Specifications) that relate to the conventional virtual storage architecture management system will be presented as literature concerning the related arts.

Patent Document 1: Japanese Unexamined Patent Publication (Kokai) No. 2004-70971

Patent Document 2: Japanese Unexamined Patent Publication (Kokai) No. 2-275544

### SUMMARY OF THE INVENTION

The present invention addresses the foregoing problems. An object of the present invention is to provide a virtual storage architecture management system capable of preventing incorrect production of a virtual storage architecture due to an operator's incorrect keystroke or the like at the time of registering a plurality of logical volumes belonging to a storage device in a pool of a virtual storage, information processing equipment for producing a virtual storage architecture, a computer-readable storage medium, and a method of producing a virtual storage architecture.

In order to accomplish the above object, according to the first aspect of the present invention, a virtual storage architecture management system that realizes a virtual storage architecture on the basis of information on specific storage areas selected from a plurality of storage areas comprises: a storage device having a plurality of storage areas; information processing equipment that performs various kinds of information processing on the storage device; and a selective linkage unit (for example, server/storage device selective linkage unit shown in FIG. 3) that establishes a plurality of paths between the information processing equipment and the plurality of storage areas in the storage device. The selective linkage unit includes an information preserver in which information on the real configuration of the storage device and information on the paths extending from the information processing equipment are stored in advance. The information processing equipment includes a control unit that acquires the information on the real configuration of the storage device and the information on the paths from the information preserver so as to calculate information on all paths required for a virtual storage architecture.

Preferably, the control unit included in the virtual storage architecture management system in accordance with the first aspect of the present invention detects specific storage areas linked to all the paths that are required for the storage architecture and that are calculated by the information processing equipment. The information processing equipment further comprises a display unit on which information on the specific storage area is displayed.

According to the second aspect of the present invention, a virtual storage architecture management system that realizes a virtual storage architecture on the basis of information on specific storage areas selected from a plurality of storage areas comprises: a plurality of storage devices each having a plurality of storage areas; information processing equipment that performs various kinds of information processing on the plurality of storage devices; and a selective linkage unit that establishes a plurality of paths between the information processing equipment and the plurality of storage areas in the plurality of storage devices. Herein, the selective linkage unit includes an information preserver in which information on the real configurations of the storage devices is stored in advance. The information processing equipment includes a control unit that samples information on the conditions for selection of any of the plurality of storage devices from the information on the real configurations of the storage devices.

Preferably, the control unit included in the virtual storage architecture management system in accordance with the second aspect of the present invention detects specific storage areas that are associated with the information on the conditions for selection of a storage device sampled by the information processing equipment. The information processing equipment includes a display unit on which information on the specific storage areas is displayed.

Moreover, according to the first aspect of the present invention, information processing equipment that performs various kinds of information processing on a storage device having a plurality of storage areas has a facility of producing a virtual storage architecture on the basis of information on a plurality of paths, which is established between the information processing equipment and the plurality of storage areas in the storage device, and information on specific storage areas selected from the plurality of storage areas. The information processing equipment includes a control unit that acquires the information on the real configuration of the storage device and the information on the paths which are stored in advance, and calculates information on all paths required for the virtual storage architecture.

Preferably, the control unit included in the information processing equipment in accordance with the first aspect of the present invention detects specific storage areas linked to all the calculated paths that are required for the storage architecture. The information processing equipment further comprises a display unit on which information on the specific storage areas is displayed.

According to the second aspect of the present invention, information processing equipment that performs various kinds of information processing on a plurality of storage devices each having a plurality of storage areas has a facility of producing a virtual storage architecture on the basis of information on a plurality of paths, which is established between the information processing equipment and the plurality of storage areas in the plurality of storage devices, and information on specific storage areas selected from the plurality of storage areas. The information processing equipment includes a control unit that samples information on the conditions for selection of any of the plurality of storage devices from the information on the real configurations of the storage devices which is stored in advance.

Preferably, the control unit included in the information processing equipment in accordance with the second aspect of the present invention detects specific storage areas associated with the sampled information on the conditions for selection of any of the storage devices. The information processing equipment includes a display unit on which information on the specific storage areas is displayed.

On the other hand, the present invention provides a computer-readable storage medium in which a program that instructs a computer to: acquire information on the real configuration of a storage device that has a plurality of zones and a plurality of storage areas dominated by the plurality of zones, and information on a plurality of paths that is established between a plurality of command lines resident in information processing equipment and the plurality of zones in the storage device; calculate information on all paths required for a virtual storage architecture; detect specific storage areas that are selected from the plurality of storage areas because they are linked to the calculated paths; and register the information on the specific storage areas in a pool of virtual storage is stored.

The present invention provides a computer-readable storage medium in which a program that instructs a computer to: sample information on the conditions for selection of any of a plurality of storage devices from information on the real configurations of the storage devices each having a plurality of zones and a plurality of storage areas dominated by the zones; detect specific storage areas that are selected from the plurality of storage areas because they are associated with the information on the conditions for selection; and register the information on the specific storage areas in a pool of virtual storage is stored.

In short, according to the present invention, primarily, information on the real configuration of a storage device and information on a plurality of paths between a server and the storage device are acquired in order to calculate information on all paths required for a virtual storage architecture. A plurality of storage areas (logical volumes) linked to the paths is detected and displayed on a display screen. Therefore, when the plurality of storage areas is registered in a pool of virtual storage, incorrect production of a virtual storage architecture due to an operator's incorrect keystroke or the like can be prevented. Furthermore, even if an operator does not recognize the real configuration of a storage device, the operator can readily produce a virtual storage architecture.

According to the present invention, secondly, information on the conditions for selection of any of a plurality of storage devices (for example, a type of storage device and a redundancy level of the configuration of a redundant array of inexpensive disks (RAID), that is, a RAID level) is sampled from information on the real configuration of a plurality of storage devices. A plurality of storage areas associated with the information on the conditions for selection is detected and displayed on a display screen. Therefore, when a plurality of storage areas is registered in a pool of a virtual storage, incorrect production of a virtual storage architecture due to an operator's incorrect keystroke or the like can be prevented. Furthermore, even if an operator does not recognize the real configurations of storage devices, the operator can readily produce a virtual storage architecture.

### BRIEF DESCRIPTION OF THE DRAWINGS

The above object and features of the present invention will be more apparent from the following description of some preferred embodiments with reference to the accompanying drawings, wherein:

FIG. 1 is a block diagram of a conventional network environment required for production of a conventional virtual storage architecture;

FIG. 2 is a block diagram conceptually showing production of a virtual storage architecture in the environment shown in FIG. 1;

FIG. 3 is a block diagram showing the configuration of a virtual storage architecture management system in accordance with a first embodiment of the present invention;

FIG. 4 is a block diagram showing the concrete configuration of a client or a server shown in FIG. 3;

FIG. 5 is a flowchart describing a procedure for producing a virtual storage architecture according to the first embodiment of the present invention;

FIG. 6 shows a display screen on which information on a first path is displayed;

FIG. 7(a) to FIG. 7(c) show the display screen on which pieces of information on the other paths are displayed;

FIG. 8 is a block diagram showing the configuration of a virtual storage architecture management system in accordance with a second embodiment of the present invention;

FIG. 9 is a flowchart describing a procedure for producing a virtual storage architecture according to the second embodiment of the present invention;

FIG. 10 shows a display screen on which the names of logical volumes in all storage devices are displayed;

FIG. 11 shows the display screen on which the names of logical volumes in a designated storage device are displayed; and

FIG. 12 shows the display screen on which the names of logical volumes configured at a designated RAID level are displayed.

### DESCRIPTION OF THE PREFERRED EMBODIMENTS

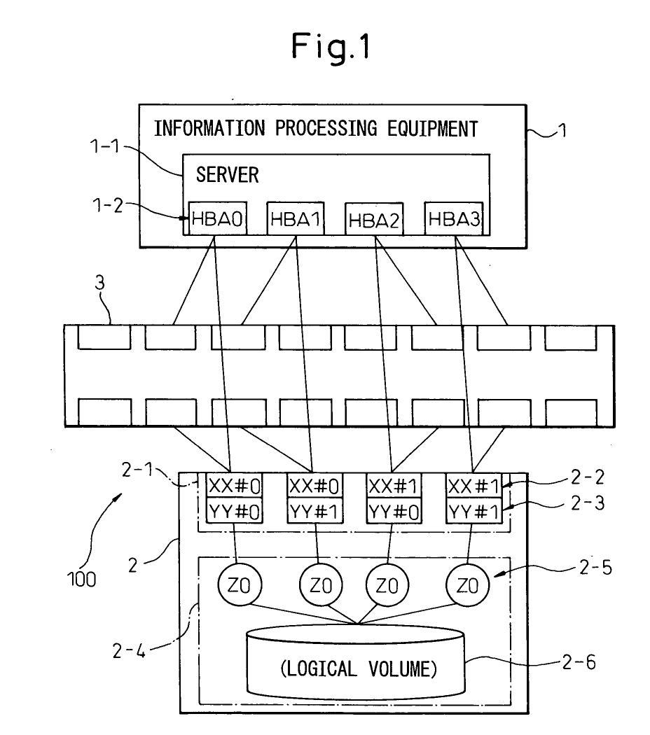

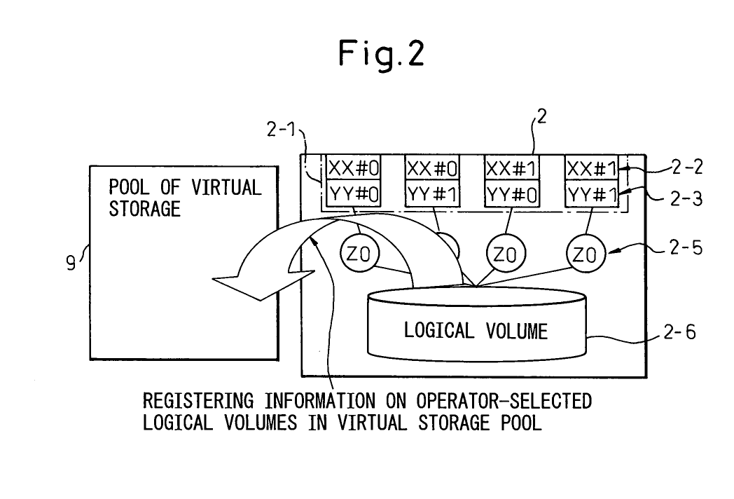

Prior to the description of virtual storage architecture management systems in accordance the embodiments of the present invention, a conventional virtual storage architecture management system and underlying problems will be described with reference to appended drawings (FIG. 1 and FIG. 2).

FIG. 1 is a block diagram showing a network environment required for producing a conventional virtual storage architecture. FIG. 2 is a block diagram conceptually showing production of a virtual storage architecture in the environment shown in FIG. 1. Herein, the configuration of a virtual storage architecture management system that realizes a virtual storage architecture in a network environment such as a SAN is schematically shown. Referring to FIG. 1 and FIG. 2, the configuration of a conventional virtual storage architecture management system 100 and actions to be performed therein will be described below.

The virtual storage architecture management system 100 shown in FIG. 1 includes a large-capacity storage device 2 such as a disk array. The storage device 2 includes a storage medium 2-4 having a plurality of zones (z0) 2-5 grouped together in association with a plurality of command lines 1-2 produced in a server 1-1, and a plurality of storage areas (may be referred to as logical volumes) 2-6 dominated by the plurality of zones 2-5. The storage device 2 includes a storage device control unit 2-1 that controls writing or reading of information in or from the storage medium 2-4 according to the plurality of command lines 1-2. The storage device control unit 2-1 includes a plurality of storage medium controllers (for example, controllers YY0 and YY1) 2-3 that mutually independently controls the plurality of zones 2-5, and a plurality of interface adaptors 2-2 (for example, adaptors XX0 and XX1) that serves as interfaces between the server 1-1 and the plurality of storage medium controllers 2-3.

Referring to FIG. 1, information processing equipment 1 includes the server 1-1. The server 1-1 transmits the plurality of command lines 1-2 (for example, a plurality of command lines HBA0, HBA1, HBA2, and HBA3 which the OS of the server produces), which are produced and stored in advance, to the storage device 2 in order to perform various kinds of information processing including writing and reading of information on the storage device 2.

In FIG. 1, a server/storage device selective linkage unit 3 that selectively links the plurality of command lines 1-2 sent from the server 1-1 with the plurality of zones 2-5 in the storage device 2 so as to group together the plurality of command lines 1-2 and the plurality of zones 2-5 is interposed between the server 1-1 included in the information processing equipment 1 and the storage device 2. The server/storage device selective linkage unit 3 has the ability to establish a plurality of paths (multiple paths) between the plurality of command lines 1-2 sent from the server 1-land the plurality of zones 2-5 in the storage device 2 by linking the plurality of command lines 1-2 with the plurality of zones 2-5 in response to a request made by an operator or the like so that the command lines and zones can be switched to others.

Part of information stored in the storage medium 2-4 in the storage device 2 may have to be managed comprehensively. In this case, a virtual storage architecture must be produced based on information on a plurality of logical volumes linked to a plurality of paths that is established between the plurality of command lines 1-2 and the plurality of zones 2-5 and selected by an operator.

For example, as shown in FIG. 2, information on a plurality of logical volumes linked to a plurality of paths selected by an operator or the like is conceptually registered in a pool 9 of a virtual storage. Thus, a virtual storage architecture is produced.

To be more specific, in the conventional virtual storage architecture management system 100, a plurality of paths is established between the plurality of command lines 1-2 sent from the server 1-1 and the plurality of zones 2-5 in the storage device 2 by way of the plurality of storage medium controllers 2-3 and the plurality of interface adaptors 2-2. Herein, four paths HBA0-XX0YY0, HBA1-XX0YY0, HBA2-XX1YY0, and HBA3-XX1YY1 are established. In order to produce a virtual storage architecture as shown in FIG. 2, a plurality of logical volumes linked to the paths must be sequentially registered in the pool 9 of the virtual storage.

In the conventional virtual storage architecture management system 100, since four paths are established, when an operator or the like manipulates a keyboard of an input unit included in the information processing equipment 1 so as to execute a CLI command, a plurality of logical volumes linked to the paths is registered in the pool 9 of the virtual storage.

In order to perform the work of registering a plurality of logical volumes in a pool of a virtual storage using a CLI command, the CLI command must be issued four times. However, the CLI command may be issued only three times because of an operator's incorrect keystroke. In this case, a virtual storage architecture having only three paths may be incorrectly produced instead of a virtual storage architecture having four paths.

At the time of introduction of a virtual storage architecture management system, if an operator wants to check whether a virtual storage architecture having four paths is actually produced, the operator must perform time-consuming manipulations. Therefore, the above problem cannot be avoided in practice because a produced virtual storage architecture cannot be checked at the time of introduction of a virtual storage architecture management system. Consequently, an incorrect definition is discovered in a virtual storage architecture while the virtual storage architecture management system is in operation. In this case, the work of registering a plurality of logical volumes in a pool of a virtual storage must be resumed from the beginning.

When information on a plurality of logical volumes included in a plurality of storage devices is registered in a pool of a virtual storage, consideration must be taken into the performance of a virtual storage architecture. Moreover, the types of storage devices must be identified, and a redundancy level of a RAID configuration adapted for redundancy of the storage devices, that is, an RAID level must be recognized. Therefore, an operator himself/herself must recognize the real configurations of the plurality of storage devices, check to which of the storage devices logical volumes to be registered belong, and recognize the RAID level.

Even in this case, logical volumes that should not be registered in the same pool of a virtual storage may be incorrectly registered because of an operator's incorrect keystroke. This problem cannot be avoided, similarly to the aforesaid one, because it is hard to check a virtual storage architecture at the time of introduction of a virtual storage architecture management system. Consequently, an incorrect definition may be discovered in a virtual storage architecture while the virtual storage architecture management system is in operation.

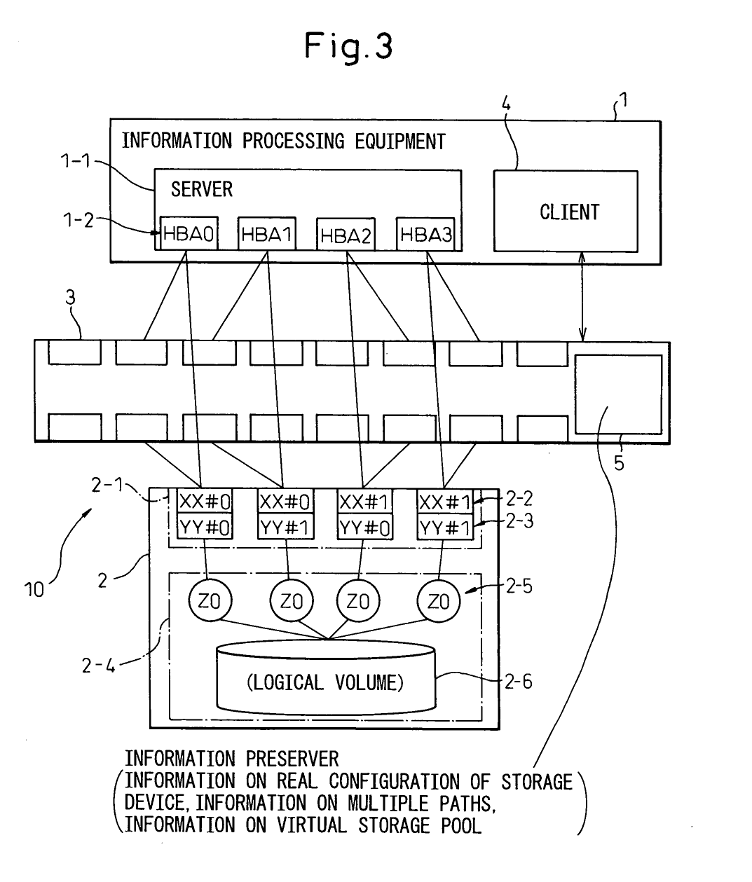

Preferred embodiments of a virtual storage architecture management system and others in accordance with the present invention which appear in efforts to solve the foregoing problems will be described with reference to appended drawings (FIG. 3 to FIG. 12).

FIG. 3 is a block diagram showing the configuration of a storage architecture management system in accordance with the first embodiment of the present invention. Herein, the configuration of the storage architecture management system 10 in accordance with the first embodiment of the present invention is schematically shown. Hereinafter, the same reference numerals will be assigned to components identical to the aforesaid ones.

The virtual storage architecture management system 10 in accordance with the first embodiment shown in FIG. 3 includes, similarly to the conventional virtual storage architecture management system shown in FIG. 1, a large-capacity storage device 2 such as a disk array. The storage device 2 includes a storage medium 2-4 such as a disk having a plurality of zones (Z0) 2-5 grouped together in association with a plurality of command lines 1-2 sent from a server 1-1, and a plurality of storage areas (may be referred to as logical volumes) 2-6 dominated by the plurality of zones 2-5. Moreover, the storage device 2 includes a storage device control unit 2-1 that controls writing or reading of information in or from the storage medium 2-4 according to the plurality of command lines 1-2. The storage device control unit 2-1 includes a plurality of storage medium controllers (for example, controllers YY0 and YY1) 2-3 that mutually independently controls the plurality of zones 2-5, and a plurality of interface adaptors 2-2 (for example, adaptors XX0 and XX1) that serves as interfaces between the server 1-1 and the plurality of storage medium controllers 2-2.

In FIG. 3, information processing equipment 1 includes the server 1-1 and a client 4. The server 1-1 transmits the plurality of command lines 1-2 (for example, a plurality of command lines HBA0, HBA1, HBA2, and HBA3 produced by the OS of the server), which is produced and stored in advance, to the storage device 2 so as to perform various kinds of information processing including writing and reading of information on the storage device 2. The client 4 issues a request for any of various kinds of information processing.

Referring to FIG. 3, a server/storage device selective linkage unit 3 (equivalent to a selective linkage unit included in the present invention) that selectively links the plurality of command lines 1-2 sent from the server 1-1 with the plurality of zones 2-5 in the storage device 2 so as to group together the plurality of command lines 1-2 and the plurality of zones 2-5 is interposed between the server 1-1 included in the information processing equipment 1 and the storage device 2. The server/storage device selective linkage unit 3 has the ability to establish a plurality of paths between the plurality of command lines 1-2 sent from the server 1-1 and the plurality of zones 2-5 in the storage device 2 by linking the plurality of command lines 1-2 with the plurality of zones 2-5 in response to an operator's request so that the command lines and zones can be switched to others. In general, the server/storage device selective linkage unit 3 is realized with a fibre-channel switch including a plurality of switching elements.

Furthermore, the server/storage device selective linkage unit 3 includes an information preserver 5 in which information on the real configuration of the storage device 2, information on the plurality of paths between the server and storage device, and information on a pool of a virtual storage are stored in advance. The information preserver 5 is realized with a random access memory (RAM) or a read-only memory (ROM).

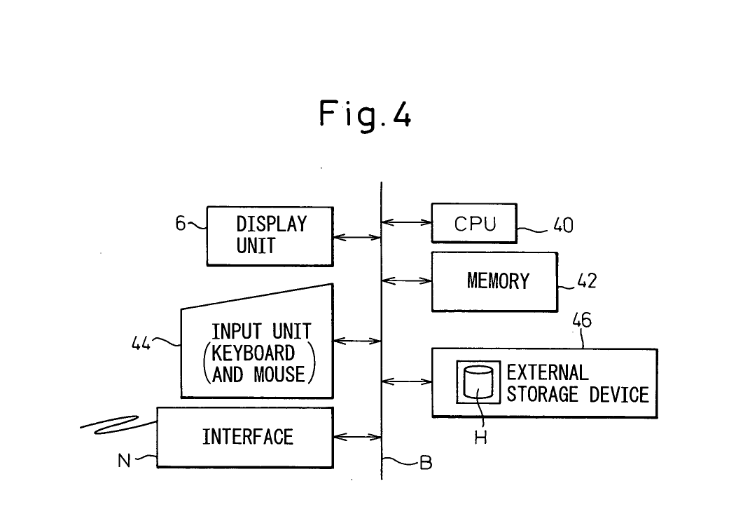

Preferably, the client 1-1 included in the information processing equipment 1 comprises: a control unit realized with a central processing unit (CPU) included in a computer; a display unit on a display screen of which information on the real configuration of the storage device, information on the plurality of paths between the server and the storage device, information on a pool of a virtual storage, or information on a plurality of logical volumes linked to the plurality of paths is displayed; a memory in which the various pieces of information and a program according to which a virtual storage architecture is produced are stored. The memory is realized with a RAM or a ROM. Moreover, the information on the real configuration of the storage device 2 and the information on the paths between the server and storage device may be stored in the memory on behalf of the information preserver 5. The control unit, display unit, and memory will be described later in conjunction with the block diagram of FIG. 4.

If part of information stored in the storage medium 2-4 included in the storage device 2 must be managed comprehensively, a virtual storage architecture must be produced based on information on a plurality of logical volumes linked to the plurality of paths established between the plurality of command lines 1-2 sent from the server 1-1 and the plurality of zones 2-5 in the storage device 2.

In order to produce a virtual storage architecture according to the first embodiment, the client 4 first displays on the display screen of the display unit the layout of the plurality of logical volumes in the storage device 2. Thereafter, an operator selects specific logical volumes from among the plurality of logical volumes by manipulating the keyboard or the like. At this time, the client 4 retrieves the information on the real configuration of the storage device 2 and the information on the plurality of paths between the server and storage device from the information preserver 5 (or the memory included in the client 4), and calculates information on all paths required for a virtual storage architecture (namely, all paths selected by an operator).

To be more specific, the client 4 acquires information on the plurality of zones and the plurality of logical volumes in the storage device 2, information on a redundancy level of an adopted RAID configuration, that is, an RAID level, information on a storage capacity, and information on disk names. Based on the pieces of information, the client 4 detects all paths between the server and the storage device, which are linked to the specific logical volumes selected by the operator, and finally determines that the detected paths correspond to all paths required for a virtual storage architecture.

Specifically, the client 4 calculates a plurality of paths to be established between the plurality of command lines 1-2 produced in the server 1-1 and the plurality of zones 2-5 in the storage device 2 by way of the plurality of storage medium controllers 2-3 and the plurality of interface adaptors 2-2. Herein, four paths HBA0-XX0YY0, HBA2-XX1YY0, HBA1-XX0YY1, and HBA3-XX1YY1 linked to a plurality of logical volumes selected by an operator are calculated. However, the present invention is not limited to the four paths.

Furthermore, the client 4 detects specific logical volumes linked to all the calculated paths and displays the information on the logical volumes on the display screen of the display unit (for example, inscribes a check mark at the names of the specific logical volumes).

Furthermore, the client 4 registers the specific logical volumes, which are linked to all the paths required for a virtual storage architecture, in a pool of a virtual storage (see FIG. 2). Consequently, all the logical volumes required for the virtual storage architecture can be correctly registered in the pool of the virtual storage.

In the first embodiment shown in FIG. 3, the client 4 included in the information processing equipment retrieves information on the real configuration of the storage device 1, and information on a plurality of paths between the server and storage device so as to calculate information on all paths required for a virtual storage architecture. Specific logical volumes linked to the paths are automatically detected and information on the logical volumes is displayed on the display screen.

Therefore, according to the first embodiment, when specific logical volumes out of a plurality of logical volumes are registered in a pool of a virtual storage, a virtual storage architecture is prevented from being incorrectly produced because of an operator's incorrect keystroke or the like. Moreover, even if an operator does not recognize the real configuration of a storage device, the operator can readily produce the virtual storage architecture.

FIG. 4 is a block diagram showing the concrete configuration of the client or server shown in FIG. 3. However, the client 4 and server 1-1 shown in FIG. 3 substantially share the same hardware configuration. Herein, the concrete hardware configuration of the client 4 having direct relation to the present invention will be shown as a representative.

Referring to FIG. 4, the control unit included in the client 4 shown in FIG. 3 is realized with a CPU 40 included in a computer. In other words, the capability of the control unit of the client 4 is realized by software (an application) resident in the computer.

The hardware configuration shown in FIG. 4 includes a memory 42 in which a program for producing a virtual storage architecture according to the present invention and relevant data are stored. The memory 42 is realized with a RAM or a ROM. A RAM or a ROM incorporated in the CPU 40 may be adopted as the memory. The information on the real configuration of the storage device 2, the information on the plurality of paths between the server and storage device, and the information on a pool of a virtual storage may be stored in the memory on behalf of the information preserver 5 (see FIG. 3).

To be more specific, the program stored in the memory 42 included in the client 4 or server 1-1 instructs: retrieval of information on the real configuration of the storage device 2, which has the plurality of zones 2-5 and the plurality of logical volumes dominated by the plurality of zones, and information on the plurality of paths established between the plurality of command lines 1-2 produced in the information processing equipment 1 and the plurality of zones 2-5 in the storage device; calculation of information on all paths required for a virtual storage architecture; detection of specific logical volumes that are selected from the plurality of logical volumes because they are linked to all the calculated paths; and registration of information on the specific logical volumes in a pool of a virtual storage.

Furthermore, preferably, if the virtual storage architecture management system 10 (or information processing equipment 1) shown in FIG. 1 is put into operation using a computer-readable storage medium (or a storage medium), the hardware configuration shown in FIG. 4 includes a storage medium H in which the foregoing program is held, for example, a hard disk. The storage medium H is driven by an external storage device 46. The storage medium included in the present invention is not limited to the foregoing one but can be provided in various forms, such as a hand-held medium including a floppy disk and a compact disk read-only memory (CD-ROM), or a fixed medium.

Furthermore, the hardware configuration shown in FIG. 4 includes an input unit 44 including a keyboard and a mouse. When an operator manipulates the keyboard or mouse of the input unit 44, information on specific logical volumes selected by the operator and information on the conditions for selection of any of storage devices (for example, the type of storage device and a redundancy level of an RAID configuration adapted to the storage device, that is, an RAID level) are preserved in the memory 42.

Furthermore, the hardware configuration shown in FIG. 4 includes a display unit 6 on the display screen of which information on the real configuration of a storage device, information on the plurality of paths between the server and storage device, and information on a plurality of logical volumes linked to the plurality of paths are displayed.

The CPU 40, memory 42, input unit 44, external storage device 46, and display unit 6 are interconnected over a bus B. Furthermore, the virtual storage architecture management system 10 including the information processing equipment 1, storage device 2, and server/storage device selective linkage unit 3 (see FIG. 3) may be connected to any other system (for example, a system including a database and backup control equipment) via an interface network such as a SAN.

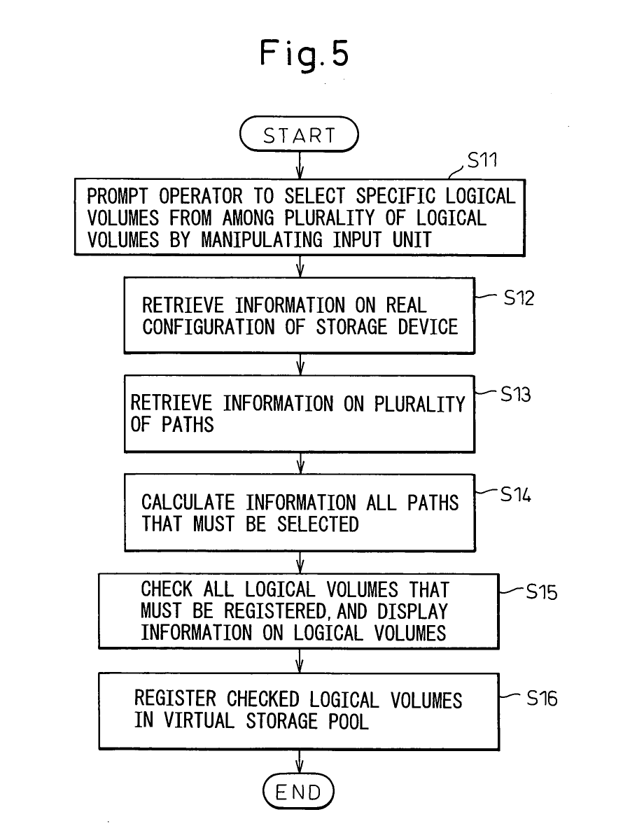

FIG. 5 is a flowchart describing a procedure for producing a virtual storage architecture that is followed in the first embodiment of the present invention. Herein, a description will be made of a sequence of steps to be followed when the CPU 40 of the client or server included in the information processing equipment in accordance with the first embodiment of the present invention (see FIG. 4) is used to produce a virtual storage architecture.

First, the client displays the layout of a plurality of logical volumes in a storage device on the display screen. At this time, similarly to step S11 in FIG. 5, the result of selection, that is, information on specific logical volumes an operator has selected from among the plurality of logical volumes by manipulating the keyboard of the input unit is displayed.

At steps S12 and S13, the client retrieves information on the real configuration of the storage device and information on the plurality of paths between the server and storage device from the information preserver (see FIG. 3) (or the memory in the client).

To be more specific, the client acquires information on the plurality of zones and the plurality of logical volumes included in the storage device, information on a RAID level or a redundancy level of a RAID configuration, information on a storage capacity, and information on disk names from the information preserver.

At step S14, the client calculates information on all paths that must be selected in order to produce a virtual storage architecture.

For example, in the embodiment shown in FIG. 3, four paths including a first path (HBA0-XX0XX0), a second path (HBA2-XX1YY0), a third path (HBA1-XX0YY1), and a fourth path (HBA3-XX1YY1) are calculated.

To be more specific, based on the above pieces of information, the client detects all paths that are linked to the specific logical volumes selected by the operator and established between the server and the storage device. Finally, the client determines that the detected paths correspond to all the paths required for production of a virtual storage architecture.

At step S15, the client checks the specific logical volumes linked to all the paths calculated at step S14, and displays information on the logical volumes on the display screen.

Finally, at step S16, the client registers the specific logical volumes, which are linked to all the paths required for production of a virtual storage architecture, in a pool of virtual storage (see FIG. 2). Consequently, all the logical volumes required for a virtual storage architecture are correctly registered in the pool of virtual storage.

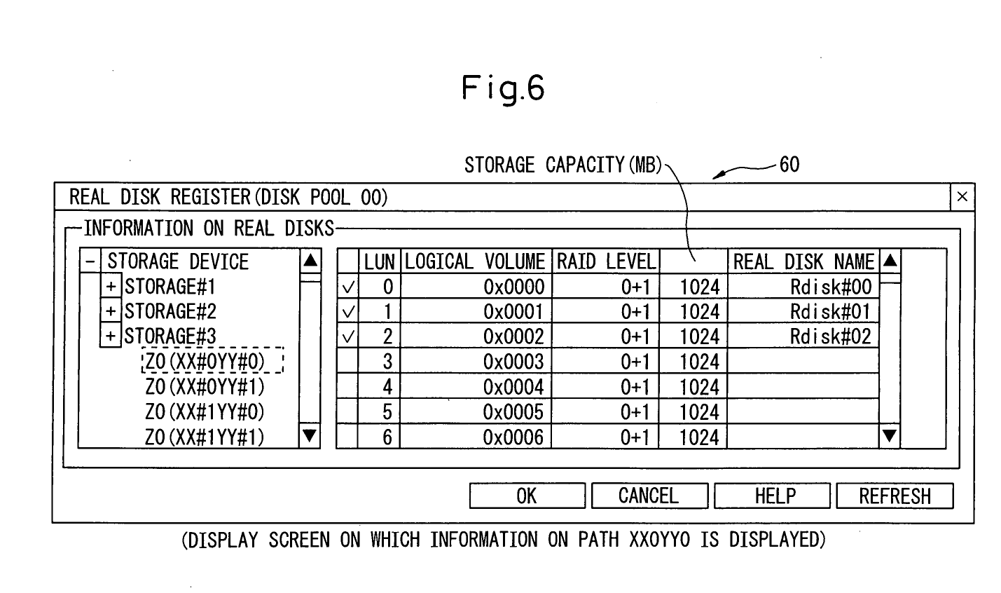

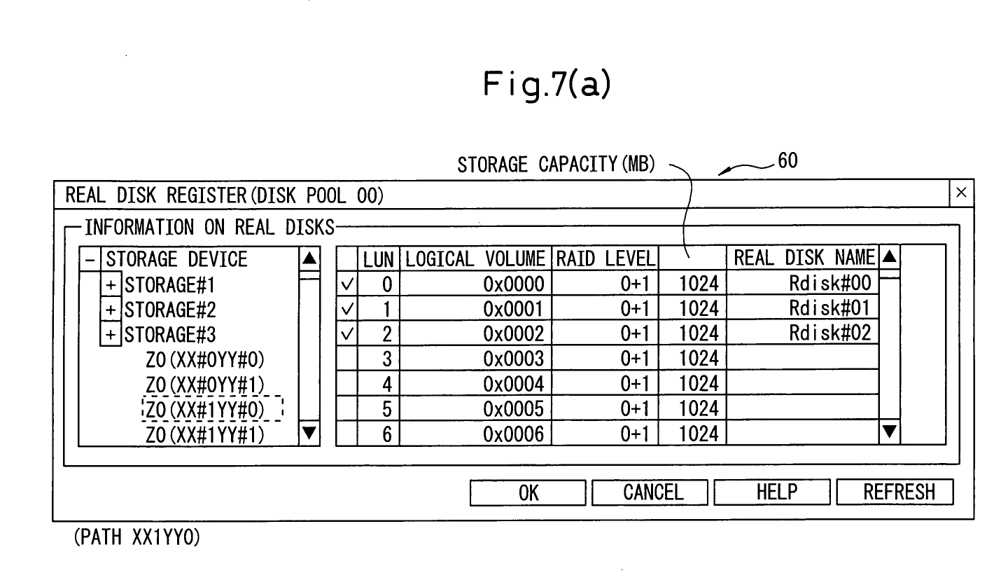

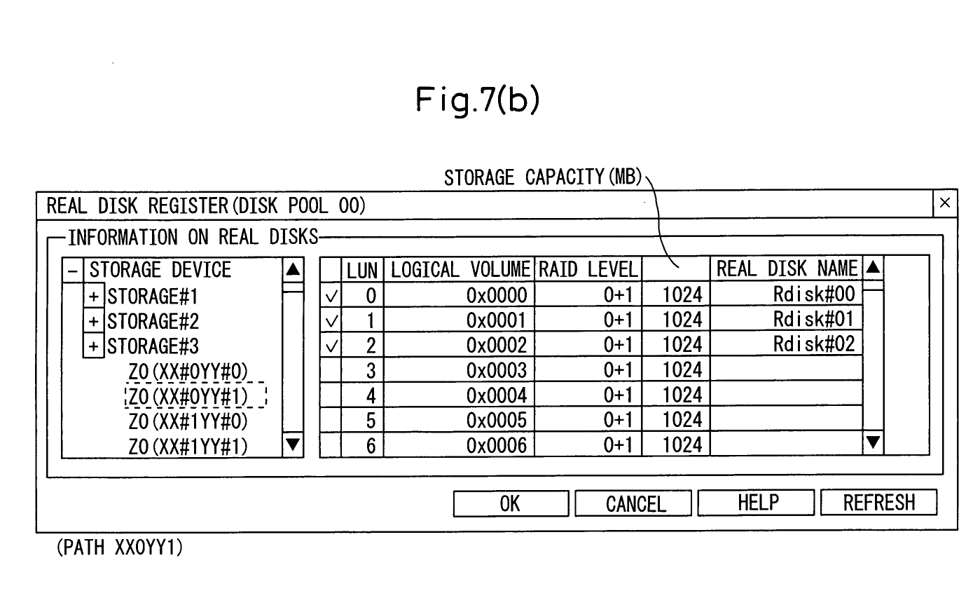

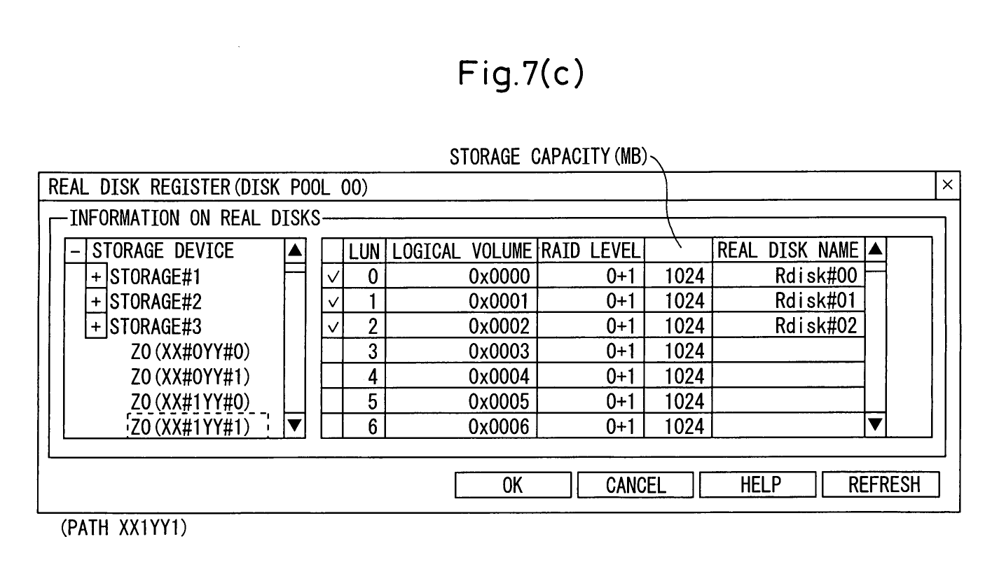

FIG. 6 shows the display screen on which information on the first path is displayed. FIG. 7(a) to FIG. 7(c) show the display screen on which pieces of information on the other paths are displayed. Herein, the specific logical volumes linked to a multipath structure composed of the four paths described in relation to the flowchart of FIG. 5 are automatically checked and information on the logical volumes is displayed on the display screen 60 of the display unit 6 (see FIG. 4).

Referring to FIG. 6, a description will be made of a case where a virtual storage architecture is produced based on logical volumes included in a storage device (device name STORAGE1) out of three storage devices (storage names STORAGE1, STORAGE2, and STORAGE3).

On the display screen 60 shown in FIG. 6, an operator first selects zones Z0 (corresponding to the zones Z0 in FIG. 3) linked to the first path (in FIG. 6, path XX0XX0) established between the server and the storage device. Thereafter, the client 4 (see FIG. 3) detects logical units (LUN0 to LUN6) subordinate to the zones Z0. At this time, information on all of seven logical volumes (0X0000 to 0X0006) corresponding to the logical units is displayed. On the display screen 60 of FIG. 6, the client 4 has detected three logical volumes (0X0000 to 0X0002) corresponding to the logical units LUN0 to LUN2.

Based on the three logical volumes (0X0000 to 0X0002) selected by the operator, the client 4 calculates information on logical volumes that are linked to the first path and that must be selected to be registered in a pool of a virtual storage, and checks all the logical volumes that must be registered. The result of the check is indicated with a check mark inscribed on the left part of the display screen. Based on the check marks, the operator recognizes that he/she has selected three logical volumes (0X0000 to 0X0002) corresponding to the logical units LUN0 to LUN2.

On the display screen 60 shown in FIG. 6, a redundancy level of a RAID configuration adapted to the storage device, that is, a RAID level (0+1), a storage capacity (1024 MB), and real disk names (Rdisk00, Rdis01, and Rdisk02) are also displayed.

The operator checks the display screen 60 to see if the check mark is appended to the names of the three logical volumes (0X0000 to 0X0002). Thereafter, when the operator clicks in an OK button, the logical volumes linked to the first path are registered in a pool of a virtual storage.

If the operator selects the other paths of the second to fourth paths established between the server and storage device (path XX1YY0 in FIG. 7(a), path XX0YY1 in FIG. 7(b), and path XX1XX1 in FIG. 7(c)), the client 4 calculates information on logical volumes that are linked to the second to fourth paths and that must be selected to be registered in a pool of a virtual storage, and checks all the logical volumes that must be registered. The results of the check are visualized as check marks sequentially displayed on the left part of the display screen 60 as shown in FIG. 7(a) to FIG. 7(c). Owing to the check marks, the operator recognizes that the three logical volumes (0X0000 to 0X0002) which correspond to the logical units LUN0 to LUN2 and are linked to the second to fourth paths have been checked.

After the operator recognizes on the display screen 60 shown in FIG. 7(a) to FIG. 7(c) that the three logical volumes (0X0000 to 0X0002) have been correctly selected, if the operator clicks in the OK button, the logical volumes linked to each of the other paths of the second to fourth paths are sequentially registered in a pool of a virtual storage. Thus, three logical volumes linked to each of four paths and required to be registered in a pool of a virtual storage can be correctly registered in the pool of virtual storage.

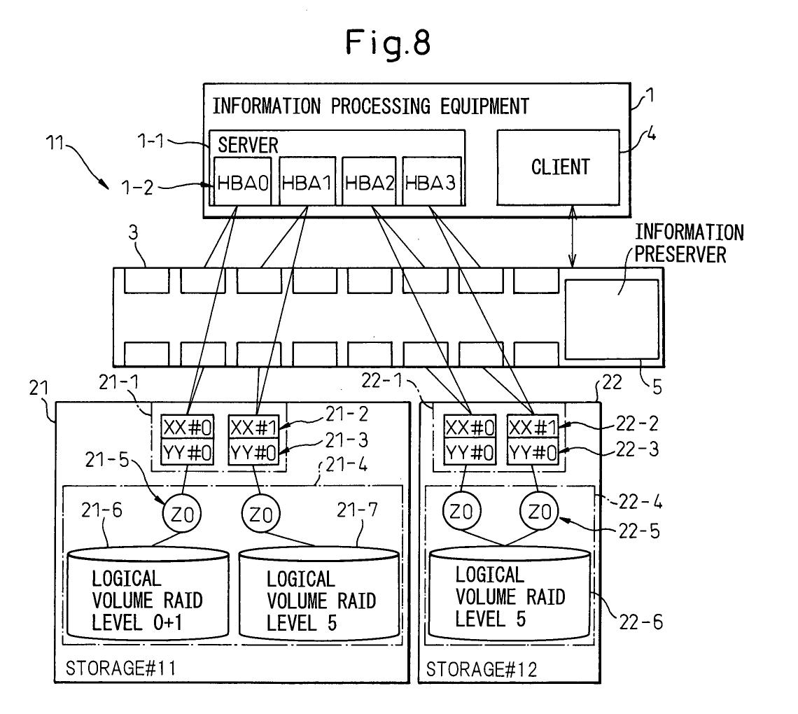

FIG. 8 is a block diagram showing the configuration of a virtual storage architecture management system in accordance with a second embodiment of the present invention. FIG. 8 is a block diagram showing the storage architecture management system in accordance with the second embodiment of the present invention. Herein, the configuration of the storage architecture management system 11 in accordance with the second embodiment of the present invention is schematically shown.

The virtual storage architecture management system 11 in accordance with the second embodiment shown in FIG. 8 includes a plurality of large-capacity storage devices 2 such as disk arrays (FIG. 8 shows two storage devices of a first storage device 21 and a second storage device 22).

The first storage device 21 (for example, device name STORAGE11) includes a first storage medium 21-4 such as a disk having a plurality of first zones (Z0) 21-5 that is grouped together in association with a plurality of command lines 1-2 produced in the server 1-1, and pluralities of first storage areas (referred to as logical volumes) 21-6 and 21-7 dominated by the plurality of first zones 21-5. The first storage device 21 includes two kinds of logical volumes, that is, the pluralities of logical volumes (pluralities of first storage areas 21-6 and 21-7) that are configured at RAID levels (0+1) and (5) respectively for redundancy of the storage device.

The first storage device 21 includes a first storage device control unit 21-1 that controls writing or reading of information in or from the first storage medium 21-4 according to the plurality of command lines 1-2. The first storage device control unit 21-1 includes a first storage medium controller (for example, YY0) 21-3 that controls the plurality of first zones 21-5 independently of one another, and a first interface adaptor 2-1 (for example, XX0 or XX1) serving as an interface between the server 1-1 and first storage medium controller 21-3.

The second storage device 22 (for example, device name STORAGE12) includes a second storage medium 22-4 having a plurality of second zones (Z0) 22-5 that is grouped together in association with the plurality of command lines 1-2 produced in the server 1-1, and a plurality of second storage areas (may be referred to as logical volumes) 22-6 dominated by the plurality of second zones 22-5. The second storage device 22 includes the plurality of logical volumes (plurality of second storage areas 22-6) configured at a RAID level (5) alone for redundancy of the storage device.

Furthermore, the second storage device 22 includes a second storage device control unit 22-1 that controls writing or reading of information in or from the second storage medium 22-4 according to the plurality of command lines 1-2. The second storage device control unit 22-1 includes a second storage medium controller (for example, YY0) 22-3 that controls the plurality of second zones 22-5 independently of one another, and a second interface adaptor 22-2 (for example, XX0 or XX1) serving as an interface between the server 1-1 and second storage medium controller 22-3.

Referring to FIG. 8, information processing equipment 1 including the server 1-1 and a client 4 is included in the same manner as that included in the virtual storage architecture management system in accordance with the aforesaid embodiment shown in FIG. 1. The server 1-1 transmits the plurality of command lines 1-2 (HBA0, HBA1, HBA2, and HBA3), which is produced and stored in advance, to the storage device 2 so as to perform various kinds of information processing including writing and reading of information on the storage device 2. The client 4 issues a request for any of various kinds of information processing.

In FIG. 8, a server/storage device selective linkage unit 3 that selectively links the plurality of command lines 1-2 produced in the server 1-1 with the pluralities of first zones 21-5 and second zones 22-5 in the storage device 2 so as to group together the plurality of command lines 1-2 and the pluralities of first and second zones 21-5 and 22-5 is interposed between the server 1-1 included in the information processing equipment 1 and the storage device 2. The server/storage device selective linkage unit 3 has a facility of establishing a plurality of paths between the plurality of command lines 1-2 produced in the server 1-1 and the pluralities of first and second zones 21-5 and 22-5 in the storage device 2 by linking the plurality of command lines 1-2 with the pluralities of first and second zones 21-5 and 22-5 so that the command lines and the zones can be switched to others.

Furthermore, the server/storage device selective linkage unit 3 includes an information preserver 5 in which information on the real configuration of the storage device 2 is stored in advance. The information preserver 5 is realized with an RAM or an ROM.

If part of the pieces of information stored in the first storage medium 21-4 in the first storage device 21 and the second storage medium 22-4 in the second storage device 22 must be managed comprehensively, a virtual storage architecture is produced based on information on a plurality of logical volumes associated with the information on the conditions for selection of any of a plurality of storage devices (for example, a type of storage device, a redundancy level of an RAID configuration, that is, an RAID level adopted for redundancy of the storage device).

When a virtual storage architecture is produced according to the second embodiment shown in FIG. 8, the client 4 first displays on the display screen of the display unit the layout of the plurality of first logical volumes in the first storage device 21 and the layout of the plurality of second logical volumes in the second storage device 22. Thereafter, an operator manipulates the keyboard or the like to select the conditions for selection of any of the first and second storage devices 21 and 22 (for example, a type of storage device and a redundancy level of an RAID configuration adapted to the storage device, that is, an RAID level).

At this time, the client 4 samples information on the conditions for selection of a storage device from information on the real configurations of the first and second storage devices 21 and 22 which is stored in advance in the information preserver (or the memory in the client 4). The client 4 then detects specific logical volumes associated with the information on the conditions for selection, and displays information on the logical volumes on the display screen of the display unit.

Furthermore, the client 4 registers all the logical volumes, of which information is displayed on the display screen of the display unit, in a pool of a virtual storage (see FIG. 2). Consequently, all logical volumes required for a virtual storage architecture are correctly registered in the pool of the virtual storage.

According to the second embodiment shown in FIG. 8, the client 4 included in the information processing equipment samples information on the conditions for selection of any of the first and second storage devices 21 and 22 (for example, a type of storage device and a redundancy level of an RAID configuration, that is, an RAID level) from information on the real configurations of the first and second storage devices 21 and 22, detects specific logical volumes associated with the information on the conditions for selection, and displays information on the specific logical volumes on the display screen.

Consequently, according to the second embodiment shown in FIG. 8, when specific logical volumes out of a plurality of logical volumes are registered in a pool of a virtual storage, a virtual storage architecture is prevented from being incorrectly produced because of an operator's incorrect keystroke. Furthermore, even if an operator does not recognize the real configuration of a storage device, the operator can readily produce the virtual storage architecture.

The control unit included in the client 4 in FIG. 8 is, similarly to the one included in the aforesaid embodiment shown in FIG. 3, realized with the CPU 40 included in a computer (see FIG. 4). In other words, the capability of the control unit included in the client 1 is realized with software (application) resident in the computer.

According to the second embodiment shown in FIG. 8, the program stored in the memory 42 included in the client 4 or server 1-1 instructs: sampling of information on the conditions for selection of any of the first and second storage devices 21 and 22 from information on the real configurations of the first and second storage devices 21 and 22 that have the plurality of first or second zones 21-5 or 22-5 and the plurality of first or second logical volumes dominated by the plurality of zones; detection of specific storage areas that are selected from among the plurality of first or second logical volumes because they are associated with the information on the conditions for selection; and registration of the information on the specific storage areas in a pool of a virtual storage.

Furthermore, if the virtual storage architecture management system 11 (or the information processing equipment 1) shown in FIG. 8 is put into operation using a computer-readable storage medium (or a storage medium), the hardware configuration shown in FIG. 4 preferably includes a storage medium H (see FIG. 4) in which the above program is preserved, for example, a hard disk.

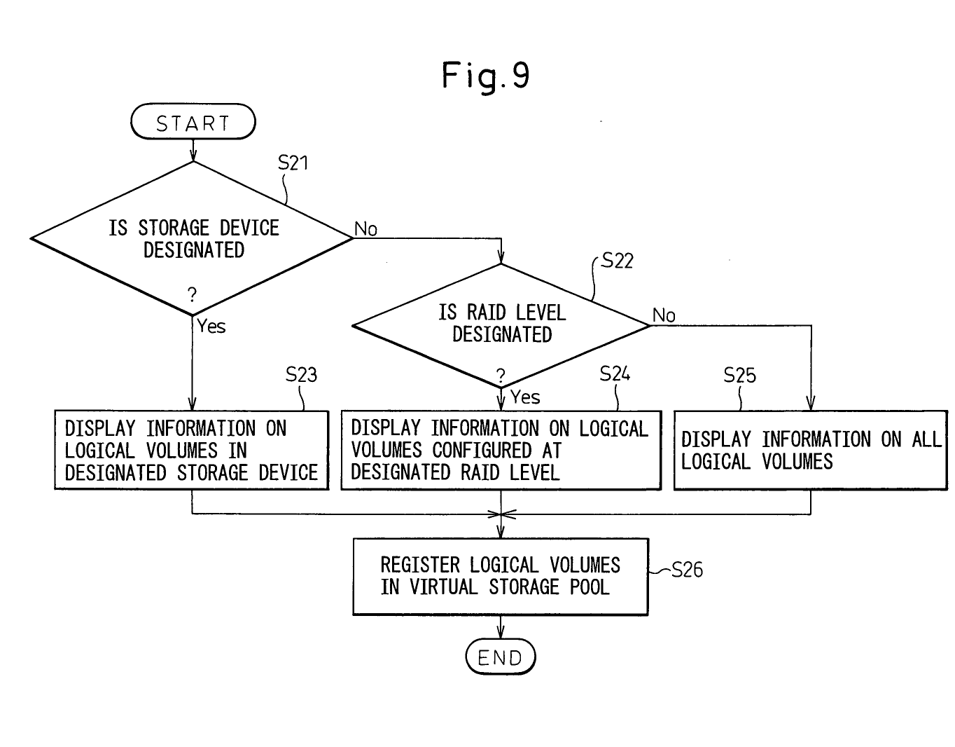

FIG. 9 is a flowchart describing a procedure of producing a virtual storage architecture according to the second embodiment of the present invention. Herein, the CPU 40 (see FIG. 4) of the client or server included in the information processing equipment in accordance with the second embodiment of the present invention is activated to follow steps for producing a virtual storage architecture.

First, the client displays on the display screen the layouts of the pluralities of first and second logical volumes in the first and second storage devices. Thereafter, as described as step S21, an operator manipulates the keyboard of the input unit to select the conditions for selection of any of the first and second storage devices (for example, a type of storage device and a redundancy level of an RAID configuration adapted to the storage, that is, an RAID level).

At this time, the client samples information on the conditions for selection of a storage device from information on the real configurations of the first and second storage devices that is stored in advance in the information preserver (see FIG. 3) (or the memory in the client), detects specific logical volumes associated with the information on the conditions for selection, and displays information on the specific logical volumes on the display screen of the display unit.

To be more specific, at step S21, the client checks whether the operator has designated the first or second storage device.

If neither the first nor second storage device is designated at step S21 and an RAID level is not designated for the first and second storage devices at step S22, the client detects all the logical volumes in the first and second storage devices and displays information on the logical volumes on the display screen of the display unit at step S25.

On the other hand, if either the first or second storage device is designated at step S21, the client detects logical volumes in the designated storage device and displays information on the logical volumes on the display screen of the display unit at step S23.

On the other hand, if neither the first nor second storage device is designated at step S21 but an RAID level is designated for the storage devices at step S22, the client detects logical volumes in the first and second storage devices that are configured at the designated RAID level, and displays information on the logical volumes on the display screen of the display unit.

Furthermore, the client 4 registers the logical volumes, of which information is displayed on the display screen of the display unit, in a pool of a virtual storage (see FIG. 2). Consequently, all logical volumes required for a virtual storage architecture can be correctly registered in the pool of the virtual storage.

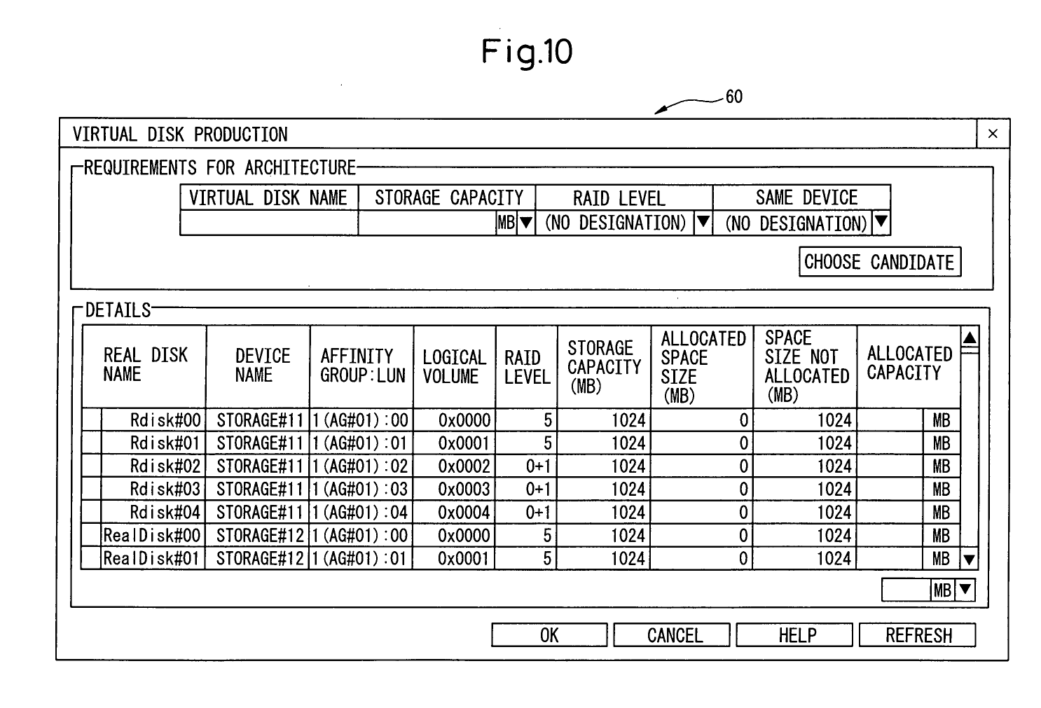

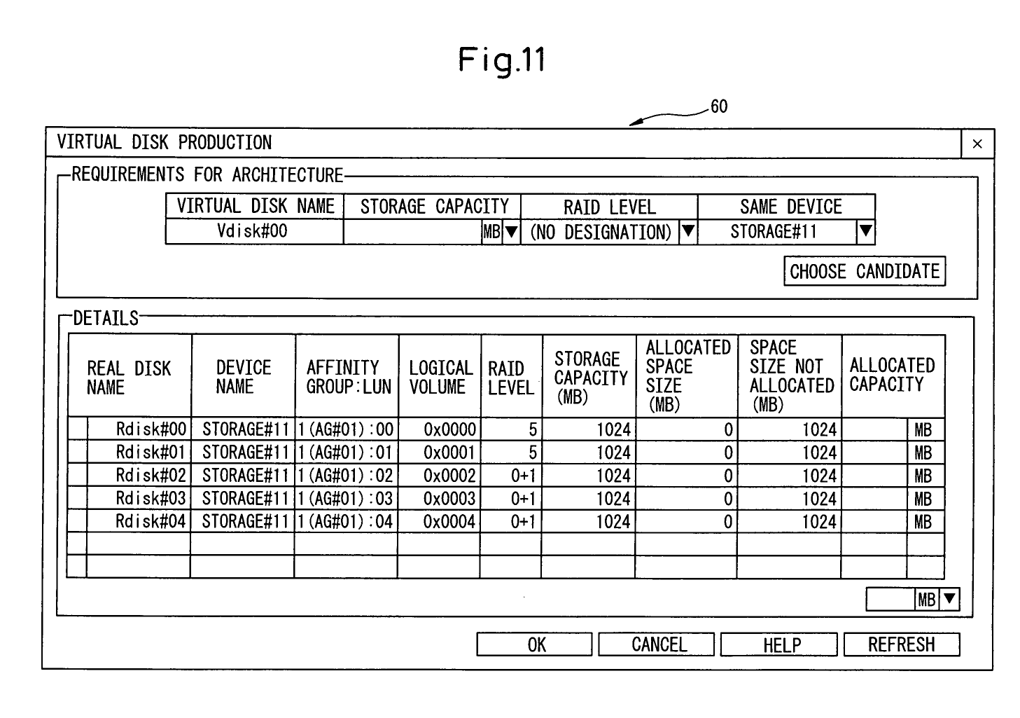

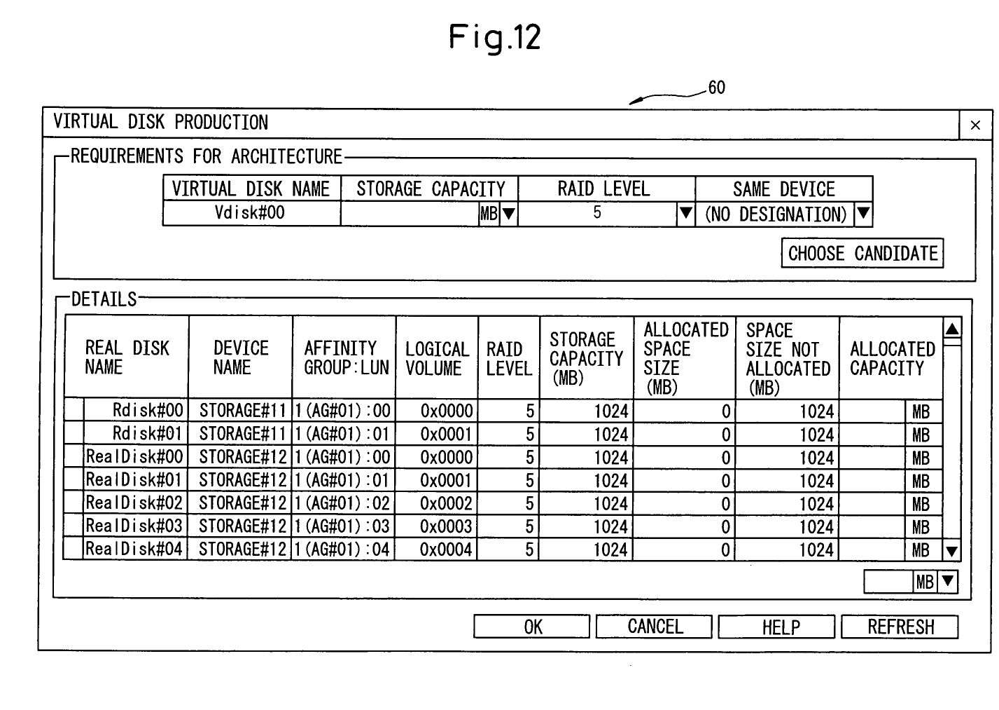

FIG. 10 shows the display screen on which information on the logical volumes in all the storage devices is displayed. FIG. 11 shows the display screen on which information on the logical volumes in a designated storage device is displayed. FIG. 12 shows the display screen on which information on logical volumes configured at a designated RAID level is displayed. Herein, specific logical volumes associated with the information on the conditions for selection of any of the first and second storage device (for example, a type of storage device and a redundancy level of an RAID configuration adapted to the storage device, that is, an RAID level) are automatically detected as described in the flowchart of FIG. 9. Information on the specific logical volumes is then displayed on the display screen of the display unit 6 (see FIG. 4).

Referring to FIG. 10 to FIG. 12, a description will be made of a case where a virtual storage architecture is produced based on specific logical volumes detected according to the conditions for selection of any of two types of storage devices (device names STORAGE11 and STORAGE12).

In this case, the first storage device (device name STORAGE11) includes two types of logical volumes (0X0000, 0X0001, and 0X0002 to 0X0004) that are configured at RAID levels (0+1) and (5). The second storage device (device name STORAGE12) includes logical volumes ((0X0000, 0X0001) that are configured at the RAID level (5).

If any one of the two types of storage devices is not designated and an RAID level is not designated for the storage devices, information on all the logical volumes in the two types of storage devices is displayed on the display screen 60 as shown in FIG. 10. This action corresponds to the step S25 described in FIG. 7.

Herein, the client 4 (see FIG. 8) displays on the display screen 60 information on all the logical volumes in the two types of storage devices (0X0000 to 0X0004, 0X0000, and 0X0001). An operator looks at the display screen 60 to readily check all the logical volumes in the two types of storage devices.

On the display screen 60 shown in FIG. 10, names of real disks included in the two types of storage devices (Rdisk00 to Rdisk02, and RealDisk00 and RealDisk01), affinity groups (1(AG01) to which the real disks belong, logical unit numbers (LUN00 to LUN04), a storage capacity (1024 MB), the sizes of allocated disk space (0 MB) or the sizes of disk space that has not been allocated (1024 MB), and allocated capacities (MB) are also displayed.

If one of the storage devices (device name STORAGE11) is designated, information on the logical volumes in the designated storage device is displayed on the display screen 60 as shown in FIG. 11. The action corresponds to step S23 described in FIG. 9.

Herein, the client 4 (see FIG. 8) narrows down information on the designated storage device (device name STORAGE11) to display only the information on the logical volumes (0X0000 to 0X0004) in the storage device on the display screen 60. An operator looks at the display screen 60 to readily check the logical volumes in the designated storage device (device name STORAGE11).

If a RAID level (5) is designated for two types of storage devices, information on logical volumes in the storage devices that are configured at the designated RAID level (5) is displayed on the display screen 60 as shown in FIG. 12. The action corresponds to step S24 described in FIG. 9.

Herein, the client 4 (see FIG. 8) narrows down information on the designated RAID level (5) to display only the information on logical volumes in the storage devices (0X0000, 0X0001, and 0X0000 to 0X0004) on the display screen 60. An operator looks at the display screen 60 to readily check the logical volumes in the storage devices that are configured at the designated RAID level (5).

In any of the cases shown in FIG. 10 to FIG. 12, information on the real configurations of storage devices is retrieved, and a plurality of logical volumes is narrowed down, according to the conditions for selection designated by an operator. Information on specific logical volumes is displayed on the display screen. Thus, even if the operator does not recognize the real configurations of the storage devices, the operator can readily check the real configurations of the storage devices and can readily produce a virtual storage architecture incorrectly.

Regarding the industrial applicability of the present invention, the present invention can be applied to a virtual storage architecture management system having a facility of producing a virtual storage architecture according to a plurality of logical volumes included in a storage device in a network environment such as a SAN in which a large-capacity storage device such as a disk array is employed, and to general information processing equipment including a client and a server.

1. A virtual storage architecture management system that realizes a virtual storage architecture on the basis of information on specific storage areas selected from among a plurality of storage areas, comprising:
a storage device having a plurality of storage areas;
information processing equipment that performs various kinds of information processing on the storage device; and
a selective linkage unit that establishes a plurality of paths between the information processing equipment and the plurality of storage areas in the storage device, wherein:
the selective linkage unit includes an information preserver in which information on the real configuration of the storage device and information on the paths extending from the information processing equipment are stored in advance; and
the information processing equipment includes a control unit that retrieves the information on the real configuration of the storage device and the information on the paths from the information preserver so as to calculate information on all paths required for a virtual storage architecture.

2. The virtual storage architecture management system according to claim 1, wherein:
the control unit detects the specific storage areas linked to all the paths that are calculated by the information processing equipment and that are required for the storage architecture; and
the information processing equipment includes a display unit on which information on the specific storage areas is displayed.

3. A virtual storage architecture management system that realizes a virtual storage architecture on the basis of information on specific storage areas selected from among a plurality of storage areas, comprising:
a plurality of storage devices each having a plurality of storage areas;
information processing equipment that performs various kinds of information processing on the plurality of storage devices; and
a selective linkage unit that establishes a plurality of paths between the information processing equipment and the plurality of storage areas in the plurality of storage devices, wherein:
the selective linkage unit includes an information preserver in which information on the real configurations of the storage devices is stored in advance; and
the information processing equipment includes a control unit that samples information on the conditions for selection of any of the plurality of storage devices from the information on the real configurations of the storage devices.

4. The virtual storage architecture management system according to claim 3, wherein:
the control unit detects the specific storage areas associated with the information on the conditions for selection of a storage device which is sampled by the information processing equipment; and
the information processing equipment further comprises a display unit on which information on the specific storage areas is displayed.

5. Information processing equipment that performs various kinds of information processing on a storage device having a plurality of storage areas, and that has a facility of producing a virtual storage architecture on the basis of information on a plurality of paths established between the information processing equipment and the storage device and information on specific storage areas selected from the plurality of storage areas, the information processing equipment comprising:
a control unit that retrieves information on the real configuration of the storage device and information on the paths, which are stored in advance, so as to calculate information on all paths required for the virtual storage architecture.

6. The information processing equipment according to claim 5, wherein the control unit detects the specific storage areas linked to all the calculated paths required for the storage architecture, and the information processing equipment further comprises a display unit on which information on the specific storage areas is displayed.

7. Information processing equipment that performs various kinds of information processing on a plurality of storage devices each having a plurality of storage areas, and that has a facility of producing a virtual storage architecture on the basis of information on a plurality of paths established between the information processing equipment and the plurality of storage areas in the plurality of storage devices and information on specific storage areas selected from among the plurality of storage areas, the information processing equipment comprising:
a control unit that samples information on the conditions for selection of any of the plurality of storage devices from information on the real configurations of the storage devices which is stored in advance.

8. The information processing equipment according to claim 7, wherein the control unit detects the specific storage areas associated with the sampled information on the conditions for selection of a storage device, and the information processing equipment further comprises a display unit on which information on the specific storage areas is displayed.

9. A computer-readable storage medium in which a program, instructing a computer to: retrieve information on the real configuration of a storage device having a plurality of zones and a plurality of storage areas dominated by the plurality of zones, and information on a plurality of paths established between a plurality of command lines produced in information processing equipment and the plurality of zones in the storage device; calculate information on all paths required for a virtual storage architecture; detect specific storage areas selected from among the plurality of storage areas and linked to the calculated paths; and register information on the specific storage areas in a pool of a virtual storage, is stored.

10. A computer-readable storage medium in which a program, instructing a computer to: sample information on the conditions for selection of any of a plurality of storage devices from information on the real configuration of a storage device having a plurality of zones and a plurality of storage areas dominated by the plurality of zones; detect specific storage areas selected from the plurality of storage areas and associated with the information on the conditions for selection; and register information on the conditions for selection in a pool of a virtual storage, is stored.

11. A virtual storage architecture management system that realizes a virtual storage architecture on the basis of information on specific storage areas selected from among a plurality of storage areas, comprising:
a storage device including a storage medium that has a plurality of zones which is grouped together, and a plurality of storage areas dominated by the plurality of zones;
information processing equipment including a server that transmits a plurality of command lines, with which various kinds of information processing are executed, to the storage device, and a client that issues a request for information processing; and
a server/storage device selective linkage unit that selectively links the plurality of command lines produced by the server with the plurality of zones in the storage device so as to establish a plurality of paths between the plurality of command lines and the plurality of zones, wherein:
the server/storage device selective linkage unit includes an information preserver in which information on the real configuration of the storage device and information on the plurality of paths are stored in advance; and
the client retrieves the information on the real configuration of the storage device and the information on the plurality of paths from an information preserver so as to calculate information on all paths required for a virtual storage architecture, and registers information on specific storage area linked to the calculated paths in a pool of a virtual storage.

12. A virtual storage architecture management system that realizes a virtual storage architecture on the basis of information on specific storage areas selected from among a plurality of storage areas, comprising:
a plurality of storage devices each including a storage medium that has a plurality of zones which is grouped together, and a plurality of storage areas dominated by the plurality of zones;
information processing equipment including a server that transmits a plurality of command lines, with which various kinds of information processing are executed, to the plurality of storage devices, and a client that issues a request for information processing; and
a server/storage device selective linkage unit that selectively links the plurality of command lines produced by the server and the plurality of zones in each of the storage devices so as to establish a plurality of paths between the plurality of command lines and the plurality of zones, wherein:
the server/storage device selective linkage unit includes an information preserver in which information on the real configurations of the plurality of storage devices is stored in advance; and
the client samples information on the conditions for selection of any of the plurality of storage devices from the information on the real configurations of the plurality of storage devices which is preserved in the information preserver, and registers information on specific storage areas associated with the information on the conditions for selection in a pool of a virtual storage.

13. A method of producing a virtual storage architecture to be implemented in information processing equipment including a server that transmits a plurality of command lines, with which various kinds of information processing are executed, to a storage device including a storage medium that has a plurality of zones which is grouped together, and a plurality of storage areas dominated by the plurality of zones, and a client that issues a request for information processing, wherein:
the client retrieves information on the real configuration of the storage device and information on the plurality of paths which are stored in advance; and
the client calculates information on all paths required for a virtual storage architecture, and registers in a pool of a virtual storage information on specific storage areas linked to the paths.

14. A method of producing a virtual storage architecture to be implemented in information processing equipment including a server that transmits a plurality of command lines, with which various kinds of information processing are executed, to a plurality of storage devices each of which includes a storage medium having a plurality of zones, which is grouped together, and a plurality of storage areas dominated by the plurality of zones, and a client that issues a request for information processing, wherein:
the client samples information on the conditions for selection of any of the plurality of storage devices from information on the real configurations of the plurality of storage devices that is stored in advance; and
the client registers information on specific storage areas, which are selected from among the plurality of storage areas and associated with the information on the conditions for selection, in a pool of a virtual storage.
